(19) United States
(12) Patent Application Publication
(10) Pub. No.: US 2014/0148142 A1
(43) Pub. Date: May 29, 2014

(54) Apparatuses and Methods for a Communication System

(71) Applicant: Broadcom Corporation, Irvine, CA (US)

(72) Inventors: Sami-Jukka HAKOLA, Kempele (FI); Samuli TURTINEN, Ii (FI); Timo KOSKELA, Oulu (FI); Anna PANTELIDOU, Oulu (FI)

(73) Assignee: Broadcom Corporation, Irvine, CA (US)

(21) Appl. No.: 14/091,577

(22) Filed: Nov. 27, 2013

(30) Foreign Application Priority Data
Nov. 28, 2012 (GB) 1221420.1

(51) Int. Cl. H04W 8/22; H04W 8/02

(52) U.S. Cl. CPC H04W 8/22; H04W 8/02
USPC 455/418

(57) ABSTRACT

Apparatuses and method for communication are provided. The solution includes determining that user equipment is out of network coverage; switching to out of network coverage operating mode; monitoring properties of out of network coverage operation; and if one or more predetermined conditions related to the properties are fulfilled controlling the transmission of a message using resources reserved to out of network coverage operation, the message comprising indication of the fulfilled conditions.

### CROSS REFERENCE TO RELATED APPLICATION

This application claims the benefit under 35 U.S.C. §119(a) and 37 CFR §1.55 to UK patent application no. GB1221420.1, filed on Nov. 28, 2012, the entire content of which is incorporated herein by reference.

### TECHNICAL FIELD

The exemplary and non-limiting embodiments of the invention relate generally to wireless communication networks. At least some embodiments of the invention relate especially to cell access in communication networks.

### BACKGROUND

In radio communication networks, such as the Long Term Evolution (LTE) or the LTE-Advanced (LTE-A) of the 3rd Generation Partnership Project (3GPP), network planning comprises the use of common base stations (e.g. Node B, (NB), evolved NB (eNB)). User equipment (UE) may communicate with another UE via the base station(s), for example. Alternatively, it is proposed that the UEs may communicate directly with each other by applying resources dedicated by the network for a device-to-device (D2D) direct communication. The D2D communication has proven to be network efficient by offloading the traffic processed in the base station(s), for example.

One part of device-to-device (D2D) communication is discovery. Discovery means basically finding other peers (in general a peer can mean an application, user, service, device, etc.) in proximity. Discovery can be implemented either using the direct radio signals between the devices or it may utilise network nodes (e.g. eNBs) in the process. One method to realize discovery is that predefined resources are allocated to a discovery channel.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

In a first exemplary embodiment of the invention, there is an apparatus for use in user equipment, the apparatus comprising: at least one processor; and at least one memory including computer program code; the at least one memory and the computer program code being configured to, with the at least one processor, cause the apparatus at least to: determine that the user equipment is out of network coverage; switch to an out of network coverage operating mode; monitor properties of out of network coverage operation; and if one or more predetermined conditions related to the properties are fulfilled control the transmission of a message using resources reserved for out of network coverage operation, the message comprising information on the fulfilled conditions.

In a further exemplary embodiment of the invention, there is an apparatus for use in user equipment, the apparatus comprising: means for determining that the user equipment is out of network coverage; means for switching to an out of network coverage operating mode; means for monitoring properties of out of network coverage operation; and means for controlling the transmission of a message using resources reserved for out of network coverage operation if one or more predetermined conditions related to the properties is fulfilled, the message comprising information on the fulfilled conditions.

In a further exemplary embodiment of the invention, there is an apparatus for use in user equipment, the apparatus comprising: at least one processor; and at least one memory including computer program code; the at least one memory and the computer program code being configured to, with the at least one processor, cause the apparatus at least to: receive a command from a network element of a communication network to initiate monitoring of messages sent using resources reserved for out of network coverage operation; detect messages transmitted by user equipment having no network coverage; prepare information based on the received messages; control the transmission of the information to the communication network.

In a further exemplary embodiment of the invention, there is an apparatus for use in user equipment, the apparatus comprising: means for receiving a command from a network element of a communication network to initiate monitoring of resources reserved for out of network coverage operation; means for detecting messages transmitted by user equipment having no network coverage; means for preparing information based on the received messages; and means for controlling the transmission of the information to the communication network.

In a further exemplary embodiment of the invention, there is an apparatus for use in a communication system, the apparatus comprising: at least one processor; and at least one memory including computer program code; the at least one memory and the computer program code being configured to, with the at least one processor, cause the apparatus at least to: control the transmission of a command to a first user equipment of the communication network to initiate monitoring of messages sent using resources reserved for out of network coverage operation; receive from the first user equipment one or more messages comprising information on at least one message transmitted by second user equipment having no network coverage; analyse the information and adjust operational parameters of a base station on the basis of the analysis.

In a further exemplary embodiment of the invention, there is an apparatus for use in a communication system, the apparatus comprising: means for controlling the transmission of a command to a first user equipment of the communication network to initiate monitoring of messages sent using resources reserved for out of network coverage operation; means for receiving from the first user equipment one or more messages comprising information on at least one message transmitted by second user equipment having no network coverage; and means for analysing the information and adjust operational parameters of the base station on the basis of the analysis.

In a further exemplary embodiment of the invention, there is an apparatus for use in a communication system, the apparatus comprising: at least one processor; and at least one memory including computer program code; the at least one memory and the computer program code being configured to, with the at least one processor, cause the apparatus at least to: receive from a base station of the communication system at least part of information on at least one message transmitted by a user equipment having no network coverage; analyse the information and adjust network parameters of the communication system on the basis of the analysis to enhance the coverage of the communication system.

In a further exemplary embodiment of the invention, there is an apparatus for use in a communication system, the apparatus comprising: means for receiving from a base station of the communication system at least part of information on at least one message transmitted by user equipment having no network coverage; and analysing the information and adjusting network parameters of the communication system on the basis of the analysis to enhance the coverage of the communication system.

In a further exemplary embodiment of the invention, there is a method for use in user equipment, the method comprising: determining that the user equipment is out of network coverage; switching to an out of network coverage operating mode; monitoring properties of out of network coverage operation; and if one or more predetermined conditions related to the properties are fulfilled controlling the transmission of a message using resources reserved for out of network coverage operation, the message comprising information on the fulfilled conditions.

In a further exemplary embodiment of the invention, there is a method for use in user equipment, the method comprising: receiving a command from a network element of a communication network to initiate monitoring of messages sent using resources reserved to out of network coverage operation; detecting messages transmitted by user equipment having no network coverage; preparing information based on the received messages; controlling the transmission of the information to the communication network.

In a further exemplary embodiment of the invention, there is a method for use in a communication system, the method comprising: controlling the transmission of a command to a first user equipment of the communication network to initiate monitoring of messages sent using resources reserved to out of network coverage operation; receiving from the first user equipment one or more messages comprising information on at least one message transmitted by a second user equipment having no network coverage; analysing the information and adjusting operational parameters of the base station on the basis of the analysis.

In a further exemplary embodiment of the invention, there is a method in a communication system, the method comprising: receiving from a base station of the communication system at least part of information on at least one message transmitted by a user equipment having no network coverage; analysing the information and adjusting network parameters of the communication system on the basis of the analysis to enhance the coverage of the communication system.

In a further exemplary embodiment of the invention, there is a computer program product embodied on a non-transitory computer-readable storage medium and comprising program instructions which, when loaded into an apparatus, execute a method for use in user equipment, the method comprising: determining that the user equipment is out of network coverage; switching to an out of network coverage operating mode; monitoring properties of out of network coverage operation; and if one or more predetermined conditions related to the properties are fulfilled controlling the transmission of a message using resources reserved for out of network coverage operation, the message comprising information on the fulfilled conditions.

In a further exemplary embodiment of the invention, there is a computer program product embodied on a non-transitory computer-readable storage medium and comprising program instructions which, when loaded into an apparatus, execute a method for use in user equipment, the method comprising: receiving a command from a network element of a communication network to initiate monitoring of messages sent using resources reserved to out of network coverage operation; detecting messages transmitted by user equipment having no network coverage; preparing information based on the received messages; controlling the transmission of the information to the communication network.

In a further exemplary embodiment of the invention, there is a computer program product embodied on a non-transitory computer-readable storage medium and comprising program instructions which, when loaded into an apparatus, execute a method for use in a communication system, the method comprising: controlling the transmission of a command to a first user equipment of the communication network to initiate monitoring of messages sent using resources reserved to out of network coverage operation; receiving from the first user equipment one or more messages comprising information on at least one message transmitted by a second user equipment having no network coverage; analysing the information and adjusting operational parameters of the base station on the basis of the analysis.

In a further exemplary embodiment of the invention, there is a computer program product embodied on a non-transitory computer-readable storage medium and comprising program instructions which, when loaded into an apparatus, execute a method in a communication system, the method comprising: receiving from a base station of the communication system at least part of information on at least one message transmitted by a user equipment having no network coverage; analysing the information and adjusting network parameters of the communication system on the basis of the analysis to enhance the coverage of the communication system.

### BRIEF DESCRIPTION OF THE DRAWINGS

Some embodiments of the present invention are described below, by way of example only, with reference to the accompanying drawings, in which

FIGS. 1 and 2 illustrate examples of a communication environment;

FIGS. 3A, 3B, 3C, 3D and 3E are flowcharts illustrating some example embodiments of the invention;

FIG. 4 is a signalling diagram illustrating an example embodiment of the invention; and

FIGS. 5A, 5B and 5C illustrate some examples of apparatuses applying some embodiments of the invention.

### DETAILED DESCRIPTION

Some embodiments of the present invention are applicable to user equipment (UE), a base station, eNodeB, a corresponding component, and/or to any communication system or any combination of different communication systems that support required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the universal mobile telecommunications system (UMTS) radio access network (UTRAN), HSPA (High Speed Packet Access), long term evolution (LTE®, known also as evolved UMTS Terrestrial Radio Access Network E-UTRAN), long term evolution advanced (LTE-A), Wireless Local Area Network (WLAN) based on IEEE 802.11 standard, worldwide interoperability for microwave access (WiMAX®), Bluetooth®, personal communications services (PCS) and systems using ultra-wideband (UWB) technology. IEEE refers to the Institute of Electrical and Electronics Engineers. For example, LTE® and LTE-A are developed by the Third Generation Partnership Project 3GPP.

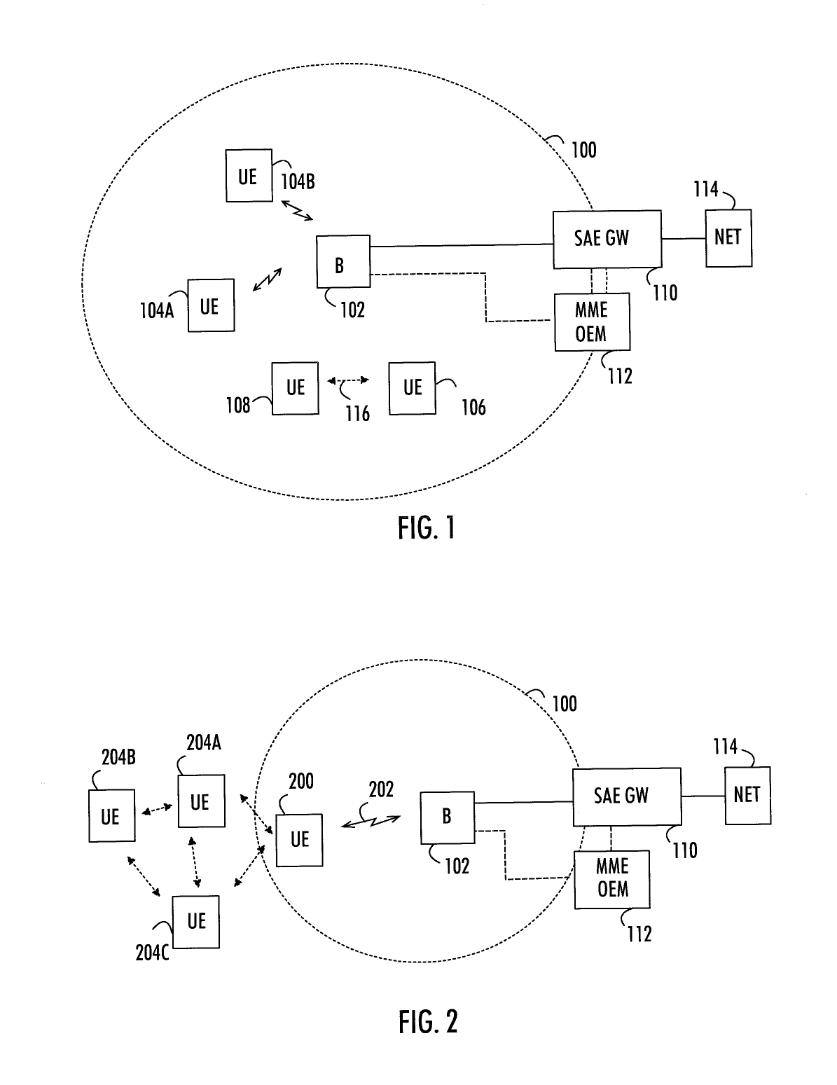

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

In the example of FIG. 1, a radio system based on LTE/SAE (Long Term Evolution/System Architecture Evolution) network elements is shown. However, the embodiments described in these examples are not limited to the LTE/SAE radio systems but can also be implemented in other radio systems.

The simplified example of a network of FIG. 1 comprises a SAE Gateway 110 and an MME/OAM server 112. Although here shown as a single entity the MME and OAM server may be different entities. The SAE Gateway 110 provides a connection to Internet (NET) 114. FIG. 1 shows a base station or an eNodeB 102 serving a cell 100. In this example, the eNodeB 102 is connected to the SAE Gateway 110 and the MME/OAM server 112.

The eNodeBs (Enhanced node Bs) of a communication system may host the functions for Radio Resource Management: Radio Bearer Control, Radio Admission Control, Connection Mobility Control, Dynamic Resource Allocation (scheduling). The MME (Mobility Management Entity) is responsible for the overall UE control in mobility, session/call and state management with assistance of the eNodeBs through which the UEs connect to the network. The OAM (Operation, Administration, and Maintenance) server controls operating parameters and maintenance of the communication network. The SAE GW 110 is an entity configured to act as a gateway between the network and other parts of communication network such as the Internet for example. The SAE GW may be a combination of two gateways, a serving gateway (S-GW) and a packet data network gateway (P-GW).

The eNodeB 102 may provide radio coverage to a cell 100. The cell 100 may be a macrocell, a microcell, or any other type of cell where radio coverage is present. Further, the cell 100 may be of any size or form, depending on the antenna system utilized. The eNodeB 102 may be used in order to provide radio coverage to the cell 100. The eNodeB 102 may control a cellular radio communication link established between the eNodeB 102 and terminal devices or user equipment 104A and 104B located within the cell 100. These communication links marked with solid arrows may be referred as conventional communication links for end-to-end communication, where the source device transmits data to the destination device via the base station 102. Therefore, the user equipment 104A and 104B may communicate with each other via the base station 102. The user equipment may be a user equipment of a cellular communication system, e.g. a computer (PC), a laptop, a handheld computer, a mobile phone, or any other user terminal or user equipment capable of communicating with the cellular communication network.

In addition to or instead of the conventional communication links, proximity services are a feature under study aiming to add capability for the UEs to discover other UEs nearby using direct radio signals such as direct device-to-device (D2D) connections that may be established among the devices. Direct communication links between two devices may be established, e.g., between terminal devices or user equipment 106 and 108 in FIG. 1. A direct communication link 116 marked with a dashed arrow may be based on any radio technology such that the terminal devices or user equipment 106 and 108 involved in the direct communication may apply communication according to any of a plurality of radio access technologies. The radio access technology of the direct communication link 116 may operate on the same frequency band as the conventional communication link and/or outside those frequency bands to provide the arrangement with flexibility. The process of finding other D2D UEs is denoted a discovery process. One method to realize discovery is that predefined resources are allocated to a discovery channel. UEs may transmit identification information on the discovery channel to indicate that they are capable for D2D communication.

One use case for the above-mentioned proximity services is in public safety systems, such as police and emergency communications. For example in the United States, LTE has been selected as the technology for a Public Safety (PS) Network. A public safety network may operate on a dedicated frequency spectrum outside the frequency spectra of the commercial cellular communication systems or, in general, commercial radio systems. A public safety device may be configured to operate in both the public safety spectrum and commercial network spectrum. However, only the public safety spectrum may be used for public safety proximity services. Public safety devices may use the proximity services or D2D connections to communicate with each other even though they belong to different public land mobile telecommunication networks (PLMNs). A public safety device may automatically use the proximity services when the coverage of the cellular communication system is not available, or the user may manually set the public safety device to use D2D discovery and communication even when network coverage is available.

Sometimes there may occur situations where PS user equipment need to operate in areas where network coverage of PS network is not complete. FIG. 2 illustrates such a situation. The figure shows a set of PS UEs, 200, 204A, 204B and 204C. Of these, only UE 200 has network coverage via a connection 202 with the eNodeB 102. Other UEs are out of coverage of the base station 102. The UEs without network coverage may utilise proximity services in communication. Thus, they may establish D2D connections with other UEs.

One known method to verify PS spectrum coverage areas is to perform drive tests where a measuring device is driving through areas to be examined. As this is a complicated procedure automated solutions have been proposed to replace the drive through method. In a so-called Minimization of Drive Tests (MDT) procedure, network coverage is studied by controlling UEs perform measurements and report results directly to the base station. Thus, the UEs or the measuring devices performing measurements are in the coverage area of an eNodeB. In immediate MDT, an eNodeB selects UEs that are in connected mode within the area to be studied and that have necessary capabilities. UEs measure given network parameters and report results to the eNodeB. In logged MDT, UE is configured to performing measurements whenever it arrives to an area to be studied and keep a log of results and report the log at given intervals.

To enhance the reliability and responsiveness of a public safety network and obtain information on coverage holes in the areas requiring immediate communication facilities a novel method utilising proximity services in connection with MDT is proposed.

In an embodiment, a public safety network operator may configure conditions for the UEs under network coverage to send information about discovered UEs that indicate in the discovery message being out of network coverage. The conditions may comprise both immediate and logged options of which usage may be configured by the network. The obtained information may be utilised to adjust eNodeB and network parameters to enhance network coverage. Thus in an embodiment, UEs which are out of network coverage are configured to measure resources reserved for proximity service and transmit data related to measurements on discovery channel. UEs having a network connection may be configured to monitor the discovery channel and transmit possible data further to eNodeB.

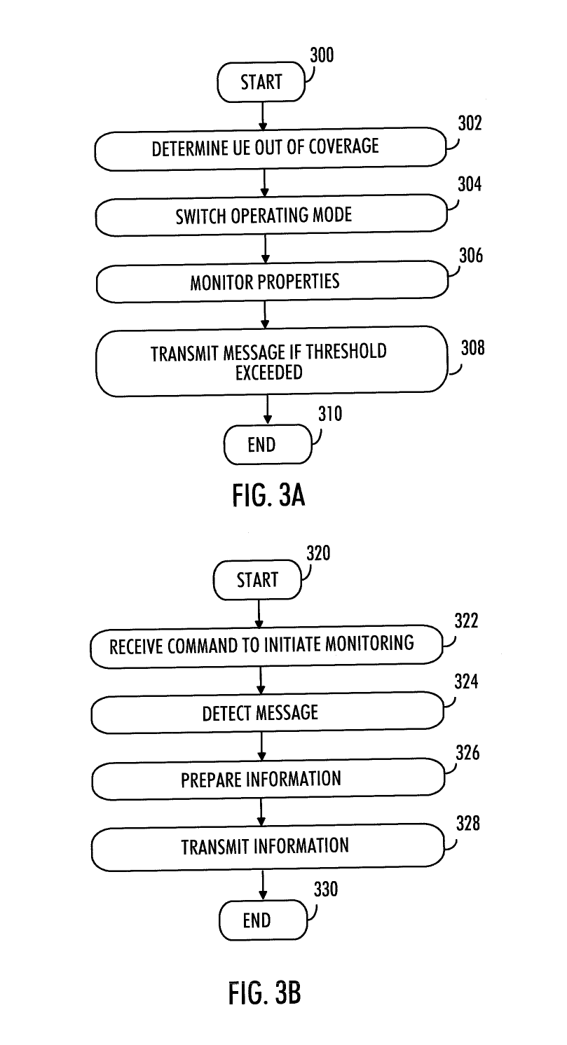

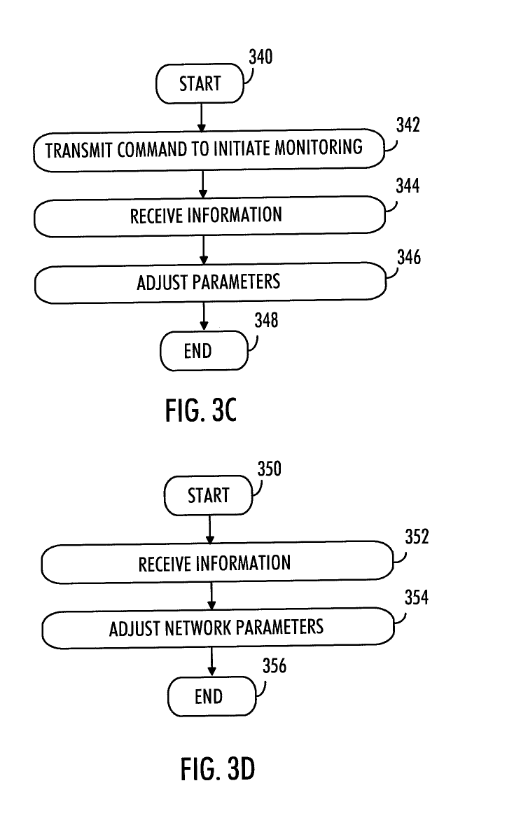

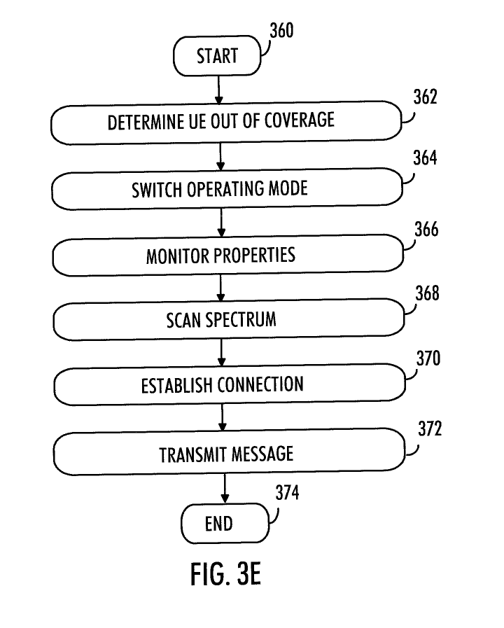

FIG. 3A is a flowchart illustrating an example embodiment of the invention. The apparatus employing the embodiment may be user equipment of a communication system or a part of user equipment, for example. The process starts at step 300.

In step 302, the apparatus is configured to determine that the user equipment is out of network coverage. Thus, the apparatus may be UE 204A, 204B or 204C of FIG. 2, for example.

In step 304, the apparatus is configured to switch to out of network coverage operating mode. This may comprise initiating proximity services operating mode. The apparatus may start sending discovery messages and find other D2D devices by monitoring resources allocated to proximity services. The resources may be pre-allocated and known to the apparatus or the apparatus may scan available spectrum to obtain information on a discovery channel.

In step 306, the apparatus is configured to monitor properties of out of network coverage operation. For example, the apparatus may be configured to monitor if one or more conditions or predetermined thresholds related to the properties are fulfilled.

In step 308, the apparatus is configured to, if one or more conditions or predetermined thresholds related to the properties are fulfilled, control the transmission of a message using resources reserved to out of network coverage operation, the message comprising information on the conditions or fulfilled thresholds.

For instance, the apparatus without network coverage could be able to indicate in its discovery message:

1) Current resources reserved to out of network coverage operation are having load higher than pre-configured threshold.

2) The apparatus is having problems in setup direct communications with other discovered apparatuses. For example, the number of consecutive failed setup attempts may be monitored.

3) The apparatus is not reaching required quality in direct communications with other discovered apparatuses to fulfil communications demand. For example, apparatus doesn't fulfil given minimum required Quality of Service (QoS) measured in service levels or minimum required lower layer (physical layer) qualities. The minimum required levels may have been pre-configured by the network operator of the apparatus. Some non-limiting examples of quality criteria include a minimum required bitrate for voice service/voice call, minimum data rate for data service and a received signal strength.

The above list is merely a non-limiting example of possible thresholds or situations. The apparatus may be configured to monitor one or more different parameters related to discovery channel or resources related to proximity services. Some part of a discovery message may be dedicated to inform about the above situations when out of network coverage. The sending of the message may be triggered when a threshold related to an observed parameter is reached.

In an embodiment, the message is a discovery message. However, basically any broadcast message sent by UE may include the information as well as a unicast message from out of coverage UE to in coverage UE when they are having a D2D connection.

In an embodiment, the apparatus sending a discovery message with measurement data may include its own position in the discovery messages. In addition, some estimation about distances to other discovered UEs that indicate being out of network coverage may be included in a discovery message.

The process ends in step 310.

FIG. 3B is a flowchart illustrating an example embodiment of the invention. The apparatus employing the embodiment may be user equipment of a communication system within network coverage or a part of user equipment, for example. Thus, the apparatus may be UE 200 of FIG. 2 or part of the UE 200, for example. The process starts at step 320.

In step 322, the apparatus is configured to receive a command from a network element of a communication network to initiate monitoring and reporting of discovery messages sent using resources reserved to out of network coverage operation for enhancing the coverage of the communication network. For example, the message may be sent by eNodeB 102 of FIG. 2.

In step 324, the apparatus is configured to detect discovery messages transmitted by user equipment having no network coverage. The apparatus may monitor a discovery channel used by the UEs which have no network coverage. The apparatus may be configured to detect also broadcast messages and unicast messages directed to the apparatus.

In step 326, the apparatus is configured to prepare information based on the received messages. For example, the apparatus may include the position of the reporting UE and estimation about distances of out of network coverage UEs found by the reporting UE in the information. The information may in the form of a MDT log.

In step 328, the apparatus is configured to control the transmission of the information to the communication network. The trigger for sending a MDT log may be the reception discovery messages comprising suitable information. In addition or alternatively, the apparatus may be configured to monitor the load of the discovery channel and another trigger for the apparatus to make a MDT report based on discovery messages may be a detected load level on pre-determined resources that are used by the UEs without network coverage.

In an embodiment, UE which has network coverage and acts as a relay to UEs that are out of coverage may have a relaying load higher than a certain threshold given by the network to the relaying UE. This may trigger the sending of the MDT log. In addition, another trigger for sending the MDT log be that UEs that are being relayed may request more relaying capability (i.e. cumulative transfer request by the out-of-coverage UEs) than the relaying UE is capable to relay.

The process ends in step 330.

FIG. 3C is a flowchart illustrating an example embodiment of the invention. The apparatus employing the embodiment may be a local area base station or an eNodeB of a communication system or a part of such an eNodeB, for example. Thus, the apparatus may be eNodeB 102 of FIG. 2 or part of the eNodeB 102, for example. The process starts at step 340.

In step 342, the apparatus is configured to control the transmission of a command to user equipment of the communication network to initiate monitoring and reporting of messages sent using resources reserved to out of network coverage operation to enhance the coverage of the communication network. More than one UE may be configured to perform the monitoring and reporting. For example, MDT reports may be used for reporting at least part of the information from the messages. The messages may be discovery messages or broadcast or unicast messages, for example.

In step 344, the apparatus is configured to receive from the user equipment one or more messages comprising at least some information from at least one message transmitted by user equipment having no network coverage.

In step 346, the apparatus is configured to analyse the information and adjust operational parameters of the apparatus on the basis of the analysis. This may enhance the coverage of the apparatus, for example. The apparatus may be able to optimize its current operational parameters to provide better coverage onto areas requiring safety critical communications, especially when direct communication between UEs without network coverage cannot fulfil the demand in a certain area.

The process ends in step 348.

FIG. 3D is a flowchart illustrating an example embodiment of the invention. The apparatus employing the embodiment may be a Core Network element, such as an OAM server or a part of such a network element, for example. Thus, the apparatus may be element 112 of FIG. 2 or part of the element 112, for example. The process starts at step 350.

In step 352, the apparatus is configured to receive from a base station of the communication system information on discovery messages transmitted by user equipment having no network coverage.

In step 354, the apparatus is configured to analyse the information and adjust network parameters of the communication system on the basis of the analysis. This may enhance the coverage of the communication system, for example.

The process ends in step 356.

FIG. 3E is another flowchart illustrating an example embodiment of the invention. The apparatus employing the embodiment may be user equipment of a communication system or a part of user equipment, for example. The process starts at step 360. The steps 362, 364, and 366 are basically similar to steps 302 to 306 of FIG. 3A.

In step 362, the apparatus is configured to determine that the user equipment is out of network coverage. Thus, the apparatus may be UE 204A, 204B or 204C of FIG. 2, for example. The apparatus may belong to a Public Safety Network which does not cover all areas.

In step 364, the apparatus is configured to switch to out of network coverage operating mode. This may comprise initiating proximity services operating mode. The apparatus may start sending discovery messages and find other D2D devices by monitoring resources allocated to proximity services. The resources may be pre-allocated and known to the apparatus or the apparatus may scan available spectrum to obtain information on a discovery channel.

In step 366, the apparatus is configured to monitor properties of out of network coverage operation. For example, the apparatus may be configured to monitor if one or more predetermined thresholds related to the properties are fulfilled.

In step 368, the apparatus is configured to scan available spectrum for a second communication system. The second communication system may be a commercial system or another radio access technology (RAT), for example.

In step 370, the apparatus is configured to establish a connection with the second communication system found during scanning

In step 372, the apparatus is configured to transmit to the Public Safety Network the message comprising indication of the fulfilled thresholds via the second communication system.

Thus, in an embodiment, another system, network or radio access technology (RAT) may be used to indicate communication incapability on public safety spectrum when out of network coverage. When a public safety UE out of network coverage meets for instance some of the conditions 1)-3) defined above, it may try to convey information to the network operator of the public safety spectrum via another LTE network or RAT if such is available for the UE.

The process ends in step 374.

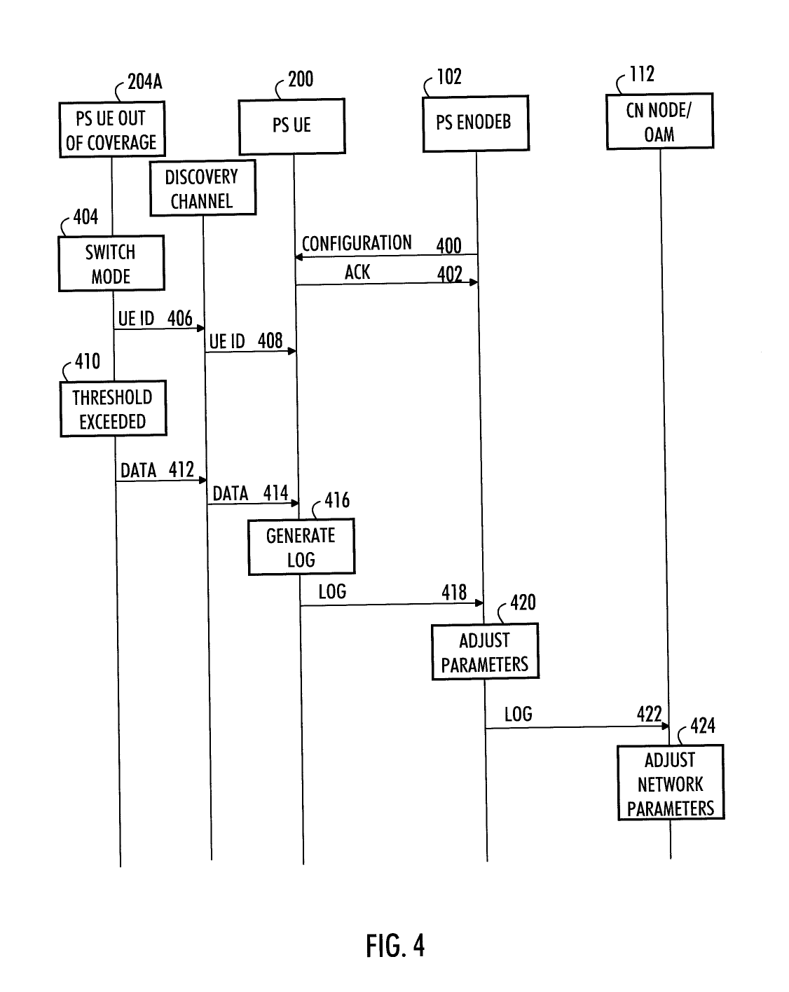

FIG. 4 is a signalling chart illustrating an example. The figure illustrates a partial example of signalling between public safety UE 204A out of network coverage, public safety UE 200 with network coverage, public safety eNodeB 102, and Core Network element 112.

The NodeB 112 transmits of a command 400 to UE 200 to initiate monitoring of discovery messages sent using resources reserved to out of network coverage operation to enhance the coverage of the communication network.

The UE 200 may be configured to acknowledge 402 the command.

The UE 204A detects that it is out of network coverage and switches to out of network coverage operating mode 404.

The above two operations may occur in any order.

The UE 204A which is out of network coverage sends regularly discovery messages 406 and other UEs around try to detect the messages, Additionally the UE monitors transmissions of other UEs on the discovery channel and performs measurements to detect occurrences of 1), 2) and 3) defined above, for example.

The UE 200 monitors the discovery channel and receives the transmissions 408.

At some phase, some condition or conditions defined to be monitored occur 410. This may trigger the UE 204A to transmit a discovery message 412 or messages on the discovery channel. The UE 204A may be configured to send messages in regular intervals.

The UE 200 with network coverage receives the message(s) 414 with information on the conditions occurred and possibly other information such as location and distance information.

The UE 200 is configured to generate 416 a MDT based on received discovery messages and send 418 the MDT log is according to configured parameters (for instance immediate or logged type configuration).

The PS eNodeB 102 receives and analyses the log. It may adjust 420 its operational parameters. For instance it may adjust its coverage area according to the received log to enhance coverage. The PS eNodeB may also forward 422 the log or a part of the log to the Core Network element 112 and/or OAM server.

The Core Network node or OAM server may adjust 424 the operating parameters of the network or part of the network, for example, aiming at providing better coverage onto areas currently lacking good communicating capabilities.

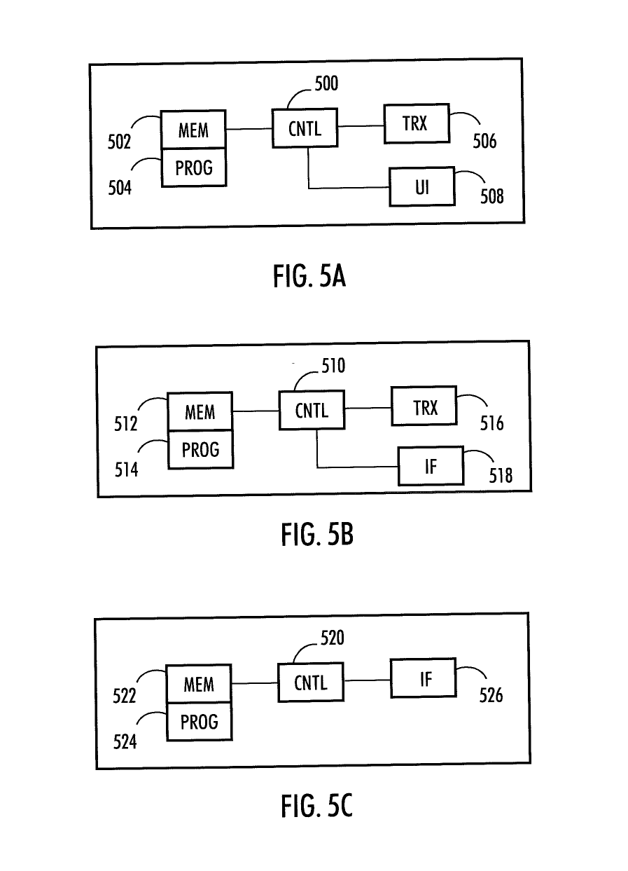

FIG. 5A illustrates a simplified example of an apparatus in which some embodiments of the invention may be applied. In some embodiments, the apparatus may be user equipment UE or a respective apparatus communicating with a base station or an eNodeB of a communications system. The apparatus may be a part or a section of user equipment (e.g. modem).

FIG. 5B illustrates a simplified example of an apparatus in which some embodiments of the invention may be applied. In some embodiments, the apparatus of FIG. 5B may be a base station or an eNodeB of a communication system or network. The apparatus may be a part or a section of a base station or an eNodeB.

FIG. 5C illustrates another simplified example of an apparatus in which some embodiments of the invention may be applied. In some embodiments, the apparatus of FIG. 5C may be a Core Network element or OEM server of a communication system or network. The apparatus may be a part or a section of a network element or OEM server.

It should be understood that the apparatuses are depicted herein as examples illustrating some embodiments. It is apparent to a person skilled in the art that the apparatuses may also comprise other functions and/or structures and not all described functions and structures are required. Although the apparatuses have been depicted as single entities, different modules and memory may be implemented in one or more physical or logical entities. In addition, each apparatus may be part of another apparatus.

FIG. 5A illustrates a simplified example of user equipment UE or a respective apparatus. The apparatus of the example includes one or more control circuitries or processing circuits (CNTL) 500 configured to control at least part of the operation of the apparatus.

The apparatus may comprise one or more memories (MEM) 502 for storing data. Furthermore the memory may store software (PROG) 504 executable by the control circuitry 500. The memory may be integrated in the control circuitry.

The apparatus may comprise a transceiver (TRX) 506. The transceiver is operationally connected to the control circuitry 500. It may be connected to an antenna arrangement (not shown) comprising one or more antennas or antenna elements. The device may also comprise a connection to a transceiver instead of a transceiver.

The software 504 may comprise a computer program comprising program code means adapted to cause the control circuitry 500 of the apparatus to control a transceiver 506.

The software 504 may comprise a computer program comprising program code means adapted to cause the control circuitry 500 of the apparatus to determine that the user equipment is out of network coverage; switch to out of network coverage operating mode; monitor properties of out of network coverage operation; and if one or more predetermined thresholds related to the properties is fulfilled control the transmission of a discovery message using resources reserved to out of network coverage operation, the message comprising indication of the fulfilled thresholds.

In addition, software 504 may comprise a computer program comprising program code means adapted to cause the control circuitry 500 of the apparatus to receive a command from a network element of a communication network to initiate monitoring of discovery messages sent using resources reserved to out of network coverage operation for enhancing the coverage of the communication network; detect discovery messages transmitted by user equipment having no network coverage; prepare information based on the received discovery messages; and control the transmission of the information to the communication network.

The apparatus may further comprise user interface (UI) 508 operationally connected to the control circuitry 500. The user interface may comprise a display which may be touch sensitive, a keyboard or keypad, a microphone and a speaker, for example.

Referring to FIG. 5B, the apparatus of the example includes one or more control circuitries or processing circuits (CNTL) 510 configured to control at least part of the operation of the apparatus.

The apparatus may comprise one or more memories (MEM) 512 for storing data. Furthermore the memory may store software (PROG) 514 executable by the control circuitry 510. The memory may be integrated in the control circuitry.

The apparatus may comprise a transceiver (TRX) 516. The transceiver is operationally connected to the control circuitry 510. It may be connected to an antenna arrangement (not shown) comprising one or more antennas or antenna elements. The apparatus may also comprise a connection to a transceiver instead of a transceiver.

The apparatus may comprise an interface (IF) 518. The interface is operationally connected to the control circuitry 510. The apparatus may be connected to network elements of the communication system or network via the interface.

The software 514 may comprise a computer program comprising program code means adapted to cause the control circuitry 510 of the apparatus to control a transceiver 516.

The software 514 may comprise a computer program comprising program code means adapted to cause the control circuitry 510 of the apparatus to control the transmission of a command to user equipment of the communication network to initiate monitoring of discovery messages sent using resources reserved to out of network coverage operation to enhance the coverage of the communication network; receive from the user equipment one or more messages comprising information on discovery messages transmitted by user equipment having no network coverage; analyse the information and adjust operational parameters of the eNodeB on the basis of the analysis to enhance the coverage of the eNodeB.

Referring to FIG. 5C, the apparatus of the example includes one or more control circuitries or processing circuits (CNTL) 520 configured to control at least part of the operation of the apparatus.

The apparatus may comprise one or more memories (MEM) 522 for storing data. Furthermore the memory may store software (PROG) 524 executable by the control circuitry 520. The memory may be integrated in the control circuitry.

The apparatus may comprise an interface (IF) 526. The interface is operationally connected to the control circuitry 520. The apparatus may be connected to network elements of the communication system or network via the interface.

The software 524 may comprise a computer program comprising program code means adapted to cause the control circuitry 520 of the apparatus to receive from a base station of the communication system information on discovery messages transmitted by user equipment having no network coverage; analyse the information and adjust network parameters of the communication system on the basis of the analysis to enhance the coverage of the communication system.

The steps, signals and related functions described in the above and attached figures are in no absolute chronological order, and some of the steps and or signals may be performed simultaneously or in an order differing from the given one. Other functions can also be executed between the steps/signals or within the steps/signals. Some of the steps/signals can also be left out or replaced with a corresponding step/signal.

The apparatuses or controllers able to perform the above-described steps may be implemented as an electronic digital computer, processing system or a circuitry which may comprise a working memory (RAM), a central processing unit (CPU), and a system clock. The CPU may comprise a set of registers, an arithmetic logic unit, and a controller. The processing system, controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as technology advances, the inventive concept can be implemented in various ways. The invention and its embodiments are not limited to the examples described above but may vary within the scope of the claims.

What is claimed is:

1. An apparatus for use in user equipment, the apparatus comprising:
at least one processor;
and at least one memory including computer program code;
the at least one memory and the computer program code being configured to, with the at least one processor, cause the apparatus at least to:
determine that the user equipment is out of network coverage;
switch to an out of network coverage operating mode;
monitor properties of out of network coverage operation;
and if one or more predetermined conditions related to the properties are fulfilled control the transmission of a message using resources reserved for out of network coverage operation, the message comprising information on the fulfilled conditions.

2. The apparatus of claim 1, further configured to address the message to a predetermined user equipment.

3. The apparatus of claim 1, further configured to send the message as a broadcast message.

4. The apparatus of claim 1, wherein the information in the message is for generating at least part of a Minimization of Drive Tests report.

5. The apparatus of claim 1, further configured to determine the location of the user equipment and include information on the location in the message.

6. The apparatus of claim 1, further configured to detect other user equipment utilising the resources reserved for out of network coverage operation; estimate the distance between the user equipment and the detected user equipment and include information on the detected user equipment and the estimated distances in the message.

7. The apparatus of claim 1, further configured to send messages at regular intervals.

8. The apparatus of claim 1, wherein the message is a discovery message.

9. The apparatus of claim 1, wherein the predetermined conditions are predetermined thresholds related to the monitored properties.

10. The apparatus of claim 1, wherein the monitored properties comprise at least one of the following:
the load of resources reserved to out of network coverage operation,
the number of consecutive failed setup attempts in device to device communication between user equipment of which at least one is out of network coverage, and
quality of service in device to device communication between user equipment of which at least one is out of network coverage.

11. The apparatus of claim 1 further configured to:
scan available spectrum for a second communication system;
establish a connection with the second communication system; and
cause the transmission of the message to the network the apparatus belongs to, the message comprising information on the fulfilled conditions via the second communication system.

12. An apparatus for use in user equipment, the apparatus comprising:
at least one processor;
and at least one memory including computer program code;
the at least one memory and the computer program code being configured to, with the at least one processor, cause the apparatus at least to:
receive a command from a network element of a communication network to initiate monitoring of messages sent using resources reserved for out of network coverage operation;
detect messages transmitted by user equipment having no network coverage;
prepare information based on the received messages; and
control the transmission of the information to the communication network.

13. The apparatus of claim 12, wherein the detected and received messages are discovery messages and/or the detected and received messages comprise information on properties of out of network coverage operation.

14. The apparatus of claim 12, wherein the properties of out of network coverage operation comprise at least one of the following:
the load of resources reserved for out of network coverage operation,
the number of consecutive failed setup attempts in device to device communication between user equipment of which at least one is out of network coverage, and
the quality of service in device to device communication between user equipment of which at least one is out of network coverage.

15. The apparatus of claim 12, wherein the detected messages comprise location information on the user equipment having no network coverage and/or estimated distances between the user equipment of which at least one is out of network coverage.

16. The apparatus of claim 12, wherein the transmitted information comprise a part of a Minimization of Drive Tests (MDT) report.

17. The apparatus of claim 12, the processing system being further configured to monitor load of the resources reserved to out of network coverage operation; and
control the transmission of the information to the communication network on the basis of the detected load.

18. The apparatus of claim 12, the processing system being further configured to receive from the communication network configuration for the transmission of the information.

19. An apparatus for use in a communication system, the apparatus comprising:
at least one processor;
and at least one memory including computer program code;
the at least one memory and the computer program code being configured to, with the at least one processor, cause the apparatus at least to:
control the transmission of a command to a first user equipment of the communication network to initiate monitoring of messages sent using resources reserved for out of network coverage operation;
receive from the first user equipment one or more messages comprising information on at least one message transmitted by second user equipment having no network coverage; and
analyse the information and adjust operational parameters of a base station on the basis of the analysis.

20. The apparatus of claim 19, wherein the information comprises at least one of the following:
information on if one or more predetermined conditions related to properties of out of network coverage operation monitored by the second user equipment are fulfilled,
data on the load of the resources reserved to out of network coverage operation,
data on the quality service in device to device communication between user equipment of which at least one is out of network coverage,
data on the number of consecutive failed setup attempts in direct communication between user equipment of which at least one is out of network coverage, and
information on the location of the user equipment out of network coverage.

21. The apparatus of claim 19, wherein the information is a part of a Minimization of Drive Tests (MDT) report.

22. The apparatus of claim 19, further configured to forward the received information to a network element of the core network of the communication system.

23. An apparatus for use in a communication system, the apparatus comprising:
at least one processor;
and at least one memory including computer program code;
the at least one memory and the computer program code being configured to, with the at least one processor, cause the apparatus at least to:
receive from a base station of the communication system at least part of information on at least one message transmitted by a user equipment having no network coverage;
analyse the information and adjust network parameters of the communication system on the basis of the analysis to enhance the coverage of the communication system.

24. The apparatus of claim 23, wherein the information comprises at least one of:
data on the load of the resources reserved to out of network coverage operation,
data on the quality service in device to device communication between user equipment of which at least one is out of network coverage,
data on the success of setting up direct communication between user equipment of which at least one is out of network coverage, and
information on the location of the user equipment out of network coverage.
